(19) United States
(12) Patent Application Publication
(10) Pub. No.: US 2007/0142024 A1
(43) Pub. Date: Jun. 21, 2007

(54) Wireless adaptor for facilitating hands-free wireless communication functionality

(76) Inventors: Richard M. Clayton, Phoenix, AZ (US); Brian J. Tucker, Mesa, AZ (US); Jean-Marc A. Villevieille, Phoenix, AZ (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/441,967

(22) Filed: May 26, 2006

Related U.S. Application Data
(63) Continuation-in-part of application No. 11/297,760, filed on Dec. 8, 2005.
(60) Provisional application No. 60/780,100, filed on Mar. 8, 2006.
(60) Provisional application No. 60/780,470, filed on Mar. 8, 2006.

(51) Int. Cl. H04Q 7/20

(52) U.S. Cl. 455/403; 709/219

(57) ABSTRACT

Described herein are embodiments that facilitate: hands-free wireless communication capability for new and existing vehicles, wireless transfer of content from a content source to a content player, or both. In one embodiment, there is provided a wireless adaptor that includes a first wireless interface operable to wirelessly access a wireless communication functionality of the wireless communication device and second wireless interface for facilitating playback at a content player wireless communication signals received at the wireless communication device.

### RELATED APPLICATIONS

This application is a continuation-in-part of U.S. patent application Ser. No. 11/297,760, filed Dec. 8, 2005, and entitled, “WIRELESS ADAPTOR FOR CONTENT TRANSFER” (Attorney Docket No. BCS03803) and claims the benefit of U.S. Provisional Patent Application No. 60/780,100 filed on Mar. 8, 2006 entitled, “WIRELESS ADAPTOR FOR FACILITATING HANDS-FREE WIRELESS COMMUNICATION FUNCTIONALITY” (Attorney Docket No. BCS04116), both of which are herein incorporated by reference in their entirety. This application is related to and incorporates by reference in their entireties the following U.S. Utility patent applications all of which are assigned to the assignee of the present application: U.S. patent application Ser. No. 11/296,975, filed Dec. 8, 2005, and entitled, “WIRELESS ADAPTOR FOR CONTENT TRANSFER” (Attorney Docket No. BCS03802); U.S. patent application Ser. No. 11/296,971, filed Dec. 8, 2005, and entitled, “GRANTING GREATER RIGHTS TO STORED CONTENT,” (Attorney Docket No. BCS03804); U.S. patent application Ser. No. 11/296,977, filed Dec. 8, 2005, and entitled, “AUTOMATIC CONTENT UPDATE FOR A TARGET DEVICE” (Attorney Docket No. BCS03805); U.S. patent application Ser. No. 11/296,990, filed Dec. 8, 2005, and entitled, “HOT CONTENT UPDATE FOR A TARGET DEVICE” (Attorney Docket No. BCS03806); and U.S. Provisional Application No. 60/780,470 filed on Mar. 8, 2006, entitled “Car Radio User Interface For Seamless Transition Between Wireless Hands-Free Phone Call And External Music Source”.

### BACKGROUND

Vehicle hands-free phone kits are becoming increasingly popular to vehicle drivers who use wireless or cellular phones in their vehicles. These phone kits allows a vehicle driver to make and receive phone calls with a cellular phone “hands-free,” i.e., without the use of the hands to maintain the cellular phone at ear level, so that the driver is free to safely operate the vehicle with both hands. A simple hands-free phone kit typically includes a headset with an attached microphone that may be wire-connected to a cellular phone. This type of hands-free phone kits is inconvenient to the driver because of the dangling wire connection that may interfere with the driver's operation of the vehicle. Another type of conventional hands-free phone kits includes a separate speaker that may be wired or wirelessly connected to a cellular phone. However, the separate speaker often provides poor audio quality. There also exist wireless hands-free phone kits that include a universal transmitter that may be clipped onto a cellular phone's earpiece and wirelessly transmits, via FM modulation, audio received by the phone during a phone call to a vehicle audio system. Thus, the driver is able to listen to phone calls made from or received by the cellular phone through existing speakers in the car audio system. This type of hands-free phone kits also suffers from poor audio quality because of the often poor quality of the microphone that accompanies the universal transmitter and the precarious nature in which the universal transmitter is attached to the earpiece of the cellular phone for audio reception. Alternatively, there exist higher quality hands-free phone kits that are typically more expensive and complex because they require special installation to leverage each particular vehicle audio system.

The advent of Bluetooth wireless technology and Bluetooth-enabled cellular phones provides vehicle makers, such as automobile manufacturers, with the necessary tools to integrate hands-free wireless communication capability with their car audio systems. For example, some automobile manufacturers offer special car audio systems with built-in Bluetooth wireless technology and microphone in newer car models to provide drivers with access to the phone functionality of their Bluetooth-enabled cellular phones through the car audio systems. However, automobile manufacturers typically charge a premium for such integrated hands-free phone functionality, which is only available for selected new car models and unavailable for existing car audio systems in older-model cars or car models from other automobile manufacturers.

Portable content players and other devices capable of playing content, such as media like music or videos, are also becoming increasingly popular and are typically designed to play the personal content of users. Users tend to use multiple media devices, such as an MP3 digital music player, wireless or cellular phone, personal digital assistant (PDA), personal computer, and a car audio system, and many of these devices are capable as content players for playing the personal content of the users. However, there is currently no fast and convenient way to transfer content between a user's multiple devices. Furthermore, the devices tend to have different user interfaces, so it is inconvenient for a user to learn and operate each device to play music or other content. For instance, some automobile manufacturers offer connector kits for connecting portable music players, such as MP3 players, to the car audio systems in their vehicles. However, these existing connector kits require users to wire connect the portable music players to docks, which further must be custom connected by wire to audio systems in the vehicles. When a portable music player is docked, its own user interface (display and control buttons) is typically disabled, and the user must use the control buttons belonging to the vehicle's audio system for limited control of the docked portable music player. Furthermore, the user is typically provided with a limited display of a numeric number to indicate the playing track on the vehicle's dashboard display. Other existing vehicle connector kits are capable of adopting the title navigation of a portable music player for display on a vehicle's dashboard to provide more detailed content information to users. However, such connector kits also require the docking of the portable music player, custom connection of the dock to the vehicle, and disabling of the player's user interface (displays and control buttons) when the player is docked.

### SUMMARY

Thus, described herein are embodiments that facilitate: hands-free wireless communication capability for new and existing vehicles, wireless transfer of content from a content source to a content player, or both, to provide users with safer, more user-friendly and convenient manners to remotely access a wireless communication device and/or content source.

Accordingly, in one embodiment, there is provided a method for facilitating hands-free wireless communication functionality of a wireless communication device that first wirelessly routes a wireless communication signal received at a wireless communication device from the wireless communication device to a wireless adaptor, via a first wireless connection facilitated by a wireless proximity network, then next routes, through a second wireless connection or a wired radio-frequency (RF) connection that is different from the first wireless connection, the first-routed wireless communication signal from the wireless adaptor to a content player for signal playback.

In another embodiment, there is provided a computer readable medium on which is encoded program code for facilitating hands-free wireless communication functionality and wirelessly providing content, the program code comprising multiple program codes for establishing a first wireless connection via a wireless proximity network with a cellular telephone, receiving stored content from the wireless communication device through the first wireless connection, wherein the stored content includes audio content, decoding the stored content as received for transmission to a content player through a second wireless connection for playback at the content player, receiving metadata for the stored content from the wireless communication device through the first wireless connection, decoding the metadata as received for transmission to the content player through the second wireless connection for display at the content player, receiving a transmission from the cellular phone of an incoming phone call received at the cellular phone via the first wireless connection, and transmitting the incoming phone call as received from the cellular phone to the content player for audio playback of the incoming phone call.

In still another embodiment, there is provided a wireless adaptor for facilitating hands-free wireless communication functionality that includes a first wireless interface operable to wirelessly access a wireless communication functionality of the wireless communication device and second interface for facilitating playback at a content player wireless communication signals received at the wireless communication device.

### DESCRIPTION OF THE DRAWINGS

Embodiments are illustrated by way of example and not limited in the following figure(s), in which like numerals indicate like elements, in which:

FIG. 1 illustrates a system for content distribution, according to an embodiment;

FIG. 2 illustrates an example of the system for content distribution shown in FIG. 1, according to an embodiment;

FIG. 3 illustrates an operation environment of a wireless adaptor, according to an embodiment;

FIG. 4 illustrates the wireless adaptor in further detail, according to an embodiment;

FIG. 5 illustrates the wireless adaptor in further detail, according to an alternate embodiment;

FIG. 6 illustrates a method for wireless content transfer, according to one embodiment;

FIG. 7 illustrates a method for hands-free wireless communication functionality, according to one embodiment; and

FIG. 8 illustrates a method for wireless content transfer and hands-free wireless communication, according to one embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

1. System Overview

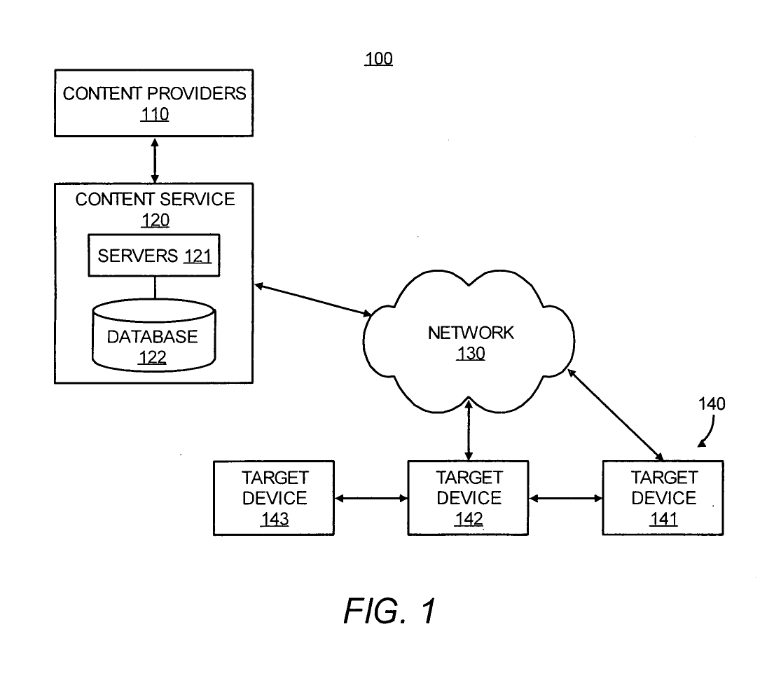

FIG. 1 illustrates a system 100 for content distribution according to an embodiment. The system 100 includes content providers 110, content service 120, network 130 and target devices 140. The content providers 110 include entities configured to provide content that may be played or otherwise consumed by users. Content may include: media such as audio, video, text; multimedia that includes two or more of audio, video and text; or other types of data. Examples of content include but are not limited to media files, such as MP3 files, other types of audio files, video files, textual music play lists, and other types of files. Examples of content providers 110 include but are not limited to news providers (such as local and cable news television stations), television studios, movie studios, music labels, online music (or other media) providers, and others.

Generally speaking, the content providers 110 provide content to the content service 120, such that the content service 120 may provide several functions. One of the functions includes receiving new content from the content providers 110 on a substantially regular basis. Another of the functions includes making the content received from the content providers 110 available to users. In addition, the content service 120 may receive content from multiple content providers 110 to provide users with a relatively large content selection. Users may obtain the content made available by the content service 120 through, for instance, one or both of subscription services and on-demand services.

The content service 120 may also automatically organize content for users and continually provide new content to users. In addition, the content service 120 may perform other functions, such as billing, user information tracking, historical data tracking, etc. The content service 120 may include a server 121 and a database 122 for storing user information and content. The server 121 may facilitate the downloading of content to the target devices 140 used by the users. It will be apparent to one of ordinary skill in the art that the server 121 may include multiple servers and the database 122 may include multiple databases depending on the size and complexity of the content service 120. For example, to support a relatively large number of users, several servers 121 and databases 122 may be needed to harvest content from the content providers 110 and provide content to users with minimal delay.

The network 130 may represent one or more networks. The network 130 may include one or more of private networks, public networks, such as the Internet, wireless networks, such as satellite and cellular networks, and local area wireless networks, such as Wi-Fi or Bluetooth networks, wired networks, local area networks, wide area networks, and any other type of communication network.

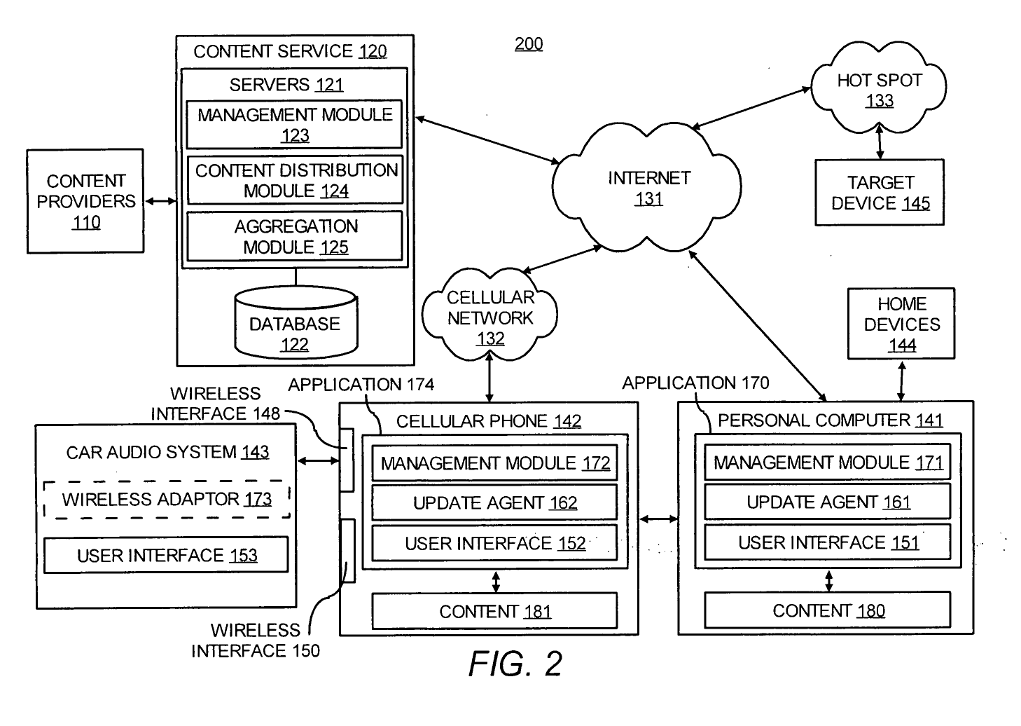

The content service 120 may provide content to the target devices 140 via the network 130. The target devices 140 may download the content from the content service 120, may receive content from one or more other target devices, or may be operable to both download content from the content service 120 and receive content from another target device. For example, as shown in FIG. 1, target devices 141 and 142 are operable to download content from the content service 120 and may be operable to receive content from another target device. As also shown in FIG. 1, the target device 143 is operable to receive content from another target device, such as the target device 142. In this example, the target device 142 may download content from the content service 120 or receive content from the target device 141, and the target device 142 transmits content to the target device 143. The content service 120 and target devices 140 are described in further detail with respect to FIG. 2. Examples of suitable target devices 140 include but are not limited to personal computers, personal digital assistants, wireless or cellular phones, car radio, home stereos, set-top boxes, MP3 players, portable video players, and other end-user devices.

2. Overview of Functionality and Advantages of Content Service

The system 100 provides a media experience for users without requiring a user to change conventional behavior to utilize the content service 120 providing the media experience. For example, the system 100 allows a user to play his or her selected audio content, such as music stations, talk radio, personal content, etc., on one of several target devices 140 that the user may be using at any particular time, such as a car radio in the car, a cellular phone when the user is on the go, a personal computer or home stereo at home. A target device may carry content selected by the user in a set of channels which are seamlessly available throughout the day on any one of many target devices. The system 100 manages the content and ensures the content is automatically replenished as it is consumed. Furthermore, an interface that is the same as or similar to a conventional device interface may be provided on the target devices 140, so the user may play desired content on any target device in a relatively quick and easy manner.

According to an embodiment, the content service 120 allows a user to configure one or more sets of channels for one or more of the target devices 140. Each channel is populated with content from a content provider or content provided by the user, referred to as the user's personal content. A channel is a data set of content, which may be of a particular type of content. For example, the content service 120 may make available hundreds of stations of content or individual pieces of content. Webcast radio and webcast television are some examples of stations of content. The content service 120 may provide one or more of the stations of content to users as a subscription service, where one or more stations are subscribed to by a user and the content for the stations is sent to one or more target devices for the user. In one example, one or more stations provide large or continuous blocks of Digital Millennium Copyright Act (DMCA) compliant streaming content. Some examples of individual pieces of content include single songs or albums, movies, video clips, etc. The content service 120 may provide an on-demand service where a user may purchase and download individual pieces of content.

Furthermore, channels may include content of a particular type, such as a sports talk channel, a popular music channel, etc. A user may configure a set of channels, hereinafter referred to as a channel set, for example, by selecting content provided by the content service 120 and of interest to the user. The channels may include high-quality, digital content, which may be commercial-free in some instances. A channel in a channel set may also include content from a user's personal collection, such as audio files stored on the user's personal computer. This channel may be programmed by play list, genre, or artist, or any other desired category or set of content.

A user may configure several channel sets, such that the user may use different channel sets at different times. For example, a user may create a first channel set for everyday use, such as for commuting to work. This channel set may include a traffic and news channel, a sports talk radio channel, as well as other channels. The user may create a second channel set for long trips, which may include, for instance, a classic rock channel and a comedy channel.

Content for the channels may be downloaded to one or more of the target devices 140 from the content service 120. The content service 120 may also refresh a target device with new content on a substantially continuous or periodic basis. For example, after content in a channel in a target device is consumed by a user, such as after the content is played, or after content becomes stale, such as after a predetermined period of time has lapsed, the content in the channel may be replenished or replaced with new content received from the content service 120 or new content that was cached in another one of the target devices 140. This update of content on a target device may be performed automatically, and may be beneficial for target devices 140 that have limited storage for storing content, such as a PDA, phone, or other device having a relatively small amount of storage space.

In addition, the target devices 140 may each include an interface that is similar to or the same as a conventional user interface widely used in at least one type of today's end user devices. Thus, a user may not be required to learn how to use the interface of a target device. Furthermore, a common interface may be provided on several target devices 140 that may be used by a single user to play content. For example, the common interface may be provided on a user's phone, personal computer, car radio, etc. Thus, the user may not need to learn how to use different interfaces for different target devices 140.

The user interfaces of the target devices 140 may emulate or include the user interfaces of conventional radio or music players with channel presets. The interfaces on the target devices 140 may provide for “one-click” channel selection, similar to clicking a channel preset button on a radio. In one example, each channel may include content populated with a type or genre of music pre-selected by the user, which allows a user to switch with one click between channels similar to switching between different radio stations on a radio. The interface may also allow a user to fast forward, rewind, or pause content.

A software application installed on a user's personal computer allows the user to manage and configure channel sets and update content on multiple target devices. Also, the content that is stored on one target device, may also be available on at least one other target device. Furthermore, the same software application or another software application may be provided on a target device that allows a user to flag songs or other content and add them to a personal wish list for purchase. U.S. patent application entitled, “Granting Greater Rights to Stored Content” (Attorney Docket Number BCS3804) incorporated by reference above describes this feature.

3. Content Service

FIG. 2 illustrates an embodiment of the system 100 for content distribution. The content service 120 is shown as including a management module 123, a content distribution module 124, and an aggregation module 125, in addition to the server 121 and the database 122 discussed with respect to FIG. 1. As referred herein, a module includes one or more software programs, applications, or routines stored on a computer readable medium (CRM) for execution by at least one processor. Embodiments of a CRM include but are not limited to an electronic, optical, magnetic, or other storage or transmission device capable of providing a processor in the receiver with computer-readable instructions. Other examples of a suitable CRM include, but are not limited to, a floppy disk, CD-ROM, DVD, magnetic disk, memory chip, ROM, RAM, an ASIC, a configured processor, any optical medium, any magnetic tape or any other magnetic medium, or any other medium from which a processor may read instructions. In addition, or alternatively, a module may refer to hardware configured to perform one or more functions described herein.

The management module 123 may coordinate information between multiple users. For example, the management module 123 may receive channel configuration information from multiple users, which may include user selections of content for channels in one or more sets of channels for the multiple users. The user selections and channel sets configured by the users may be stored in the database 122 along with additional channel configuration information added by the content service 120, such as permissions and special attributes or rules for content consumption, that is related to the user selections and configurations. The database 122 is queried subsequently to determine the content to provide to the users. In one embodiment, the management module 123 generates a web based user interface which allows a user to log into the content service 120, register with the content service 120 and set preferences, and configure channel sets.

For example, a user connects to the content service 120 via the network 130 shown in FIG. 1, which may include the Internet 131 and/or other networks shown in FIG. 2, using a personal computer 141. The user provides user information to the content service 120, which is stored in the database 122. The management module 123 may prompt a user for channel configuration information, such as a selection of a content type for each channel. For example, the user may select news, traffic, and weather for channel 1, sports talk radio for channel 2, pop music for channel 3, alternative music for channel 4, classic rock music for channel 5, and classical music for channel 6. The management module 123 stores the user selections in the database 122, and channels 1-6 are populated with content corresponding to the associated user selections, and related channel configuration information added by the content service 120, using the content distribution module 124. It should be readily understood that six channels have been described above for purposes of illustration and not of limitation. Therefore, any reasonably suitable number of channels may be available for configuration without departing from the scope of the system 100.

Alternatively, the management module 123 may prompt the user for user information, and channels may be selected for the user based on the user information. For example, the user may provide demographic information or a selection of favorite artists. Several channels may be selected for a channel set for the user based on this information. The user may select some of the channels for a channel set. Default channels may also be provided. Also, several channel sets may be configured for each user.

The content distribution module 124 sends content for channel sets to one or more target devices 140. The content distribution module 124 may determine the content to send to the target devices based on the related channel configuration information. For example, the content distribution module 124 retrieves channel configuration information for a selected set of channels from the database 122. In addition, the content distribution module 124 may send content for the respective channels to one or more target devices 140.

The aggregation module 125 receives, for example, content and play lists from the content providers 110 and stores the information in the database 122, such that the content may be distributed to users as needed.

4. Personal Computer User Gateway for Content Service

Several target devices 140 are shown in FIG. 2. The target devices 140 are shown as comprising a personal computer 141, a wireless or cellular phone 142, a car audio system 143 (or any other vehicle audio/video or entertainment system), and a home device 144. These are examples of some target devices 140 that may be used by a user. It will be apparent that other target devices 140 may also be used, such as other portable content devices (for instance, MP3 players), vehicle audio systems, home media servers, etc.

Some of the target devices 140 shown in FIG. 2 are connected to the content service 120 via a network. For example, the personal computer 141 is depicted as being connected to the content service 120 via the Internet 131. The cellular phone 142 is depicted as being connected to the content service 120 via a cellular network 132 and the Internet 131. In addition, a target device 145 is depicted as being connected to the content service 120 via a “hot spot” 133 and the Internet 131. Although not shown, additional target devices 140 may be connected to the content service 120 using one or more private networks, as opposed to a public network such as the Internet 131, and the content service 120 may provide a non-web-based content service. In one embodiment, the content service 120 includes a web service, which the user may log into using the personal computer 141 or another target device. In this embodiment, the content for the channels may be downloaded to one or more target devices 140 via the Internet 131.

The personal computer 141 may include an application 170 having a management module 171, an update agent 161, and a user interface 151. The management module 171 generally allows the user to determine and send channel configuration information for configuring selected channel sets to the content service 120. The channel configuration information may include the selection of content to place in the selected channel sets.

Examples of content that may be selected for a channel set may include genre-oriented music stations, talk content, the user's personal content, etc. Genre-oriented music content may be selected from a catalog listing a relatively large number of stations or individual content provided by the content providers 110. In addition, a single music channel may deliver a continuous set of music tracks on a target device. Talk content may also be selected from a catalog of talk content channels, which may be updated periodically, such as hourly, daily or weekly. In addition, content from more than one content provider may be placed in a single channel set. The user's personal content may be stored on the personal computer 141, which the management module 171 may discover. As such, a user may sort through various content in various manners and may move individual tracks of content or large blocks of content to a channel in a channel set.

The update agent 161 generally receives content from the content service 120 and may refresh content 180 stored on the personal computer 141 on a periodic basis. For instance, the update agent 161 caches the content 180 at the personal computer 141. The content 180 may include content received from the content distribution module 124 of the content service 120.

The update agent 161 also controls the transfer of content 180 to other target devices 140. For example, when the cellular phone 142 is connected to or otherwise interfaces with the personal computer 141, content for one or more selected channel sets may be transferred to the cellular phone 142. In one example, the transfer of content 180 may be performed as a substantially automatic feature when the cellular phone 142 is connected to the personal computer 141, whereby the user does not need to issue a transfer command. The update agent 161 may control the transfer of content 180 to the cellular phone 142, such that new content may be experienced from one or more play lists.

In addition, the update agent 161 may control the transfer of content 180 to generally enable the new content to be stored on the cellular phone 142 while staying within the limitations of the cellular phone's 142 storage capabilities. Thus, at least a portion of the content 180 may be stored on the cellular phone 142, which is indicated as content 181. Similarly, home devices 144, such as a home stereo or set-top box, may also receive content 180 from the personal computer 141. Instead of a personal computer 141, a server, such as a home media server, or another device may be used to receive and cache content 180 from the content service 120, without departing from a scope of the system 200.

The personal computer 141 may also include a user interface 151 that provides for “one-click” selection of channels and emulates a conventional interface. In one embodiment, the user interface 151 includes a GUI interface that a user may click to control playback and to select a channel. In addition, or alternatively, the user interface 151 may include hardware, such as buttons, wheels, keys, etc.

5. Portable Content Device

A portable content device, such as the cellular phone 142, PDA, MP3 player, and the like, may include an application 174 having a management module 172, an update agent 162, and a user interface 152. The management module 172 generally allows the user to determine and send channel configuration information for configuring selected channel sets to the content service 120, in manners similar to those described above with respect to the management module 171 of the personal computer 141. In certain instances, the management module 172 may be considered optional for the application 174, since management of the application 174 may be performed by the personal computer 141.

The update agent 162 of the cellular phone 142 generally controls updating of the content 181, which may include new content received from the content service 120 via the cellular network 132, the Internet 131, a wireless proximity network such as Bluetooth or Wi-Fi (802.11) as further discussed later, or any combination thereof, as routed from the content service 120 or through the personal computer 141. For example, the content 181 may comprise new cached content received from the content service 120 as routed through the internet 131 and cellular network 132, as shown in FIG. 2. In another example, the content 181 may comprise new cached content received from the personal computer 141 via a wired connection or a wireless proximity network.

The update agent 162 of the cellular phone 142 may also manage the receipt of content from one or both of the content service 120 and the personal computer 141. More particularly, for instance, the update agent 162 may control the receipt of one type of content from the content service 120 and another type of content from the personal computer 141. For example, the update agent 162 may control the receipt of content, such that, content required to be updated relatively frequently (hot content), such as traffic information, is received from the cellular network 132. In another example, the update agent 162 may control the receipt of content such that hot content is received from the personal computer 141 before such content expires (without going through the cellular network 132 or any other wireless telecommunication network). In addition, the update agent 162 may control the receipt of cold content, which are content that may be updated less frequently, to be received from the personal computer 141. In this example, the personal computer 141 may download the cold content from the content service 120. Furthermore, when the cellular phone 142 is connected to or otherwise interfaces with the personal computer 141, the cold content may be updated on the cellular phone 142. It will be apparent to one of ordinary skill in the art that cold content, such as music, may also be downloaded to the cellular phone 142 via the cellular network 132.

As shown in FIG. 2, the cellular phone 142 is also depicted as including a wireless interface 148, which may be used to connect to the content service 120 via hot spots 133, the personal computer 141, other target devices 140, etc. The cellular phone 142 further includes a wireless interface 150, which may be used to transfer content 181 to the car audio system 143. Alternatively, the wireless interfaces 148 and 150 may combine as a single wireless interface that performs all functions of the wireless interfaces 148 and 150.

Playback of the content 181 may be controlled via the user interface 152 of the cellular phone 142. For example, the user interface 152 may include controls to enable the selection of a preset channel, to rewind, fast forward, pause, play, etc.

Although not shown, the cellular phone 142 may comprise a device configured to provide the functionalities of multiple devices. For example, the cellular phone 142 may include an MP3 player, PDA, camera, video player, etc.

6. Wireless Communication Device

A wireless communication device, such as the cellular phone 142, is operable to provide a user with wireless communication functionality. As referred herein, wireless communication functionality includes functions relating to wireless communication facilitated by a wireless communication device, such as the cellular phone 142, and operation thereof. Examples of wireless communication functionality include but are not limited to initiating an outgoing phone call, receiving an incoming phone call, accepting an incoming phone call, rejecting an incoming phone call, accessing history of phone calls, redialing a phone number, and searching for a name or phone number in stored phone list. In one embodiment, the wireless communication device, such as the cellular phone 142, is also capable of establishing a communication link via a wireless proximity network. As referred herein, a wireless proximity network includes any wireless network that is capable of providing short-range wireless communication links among networked devices. Examples of a wireless proximity network includes but are not limited to personal area networks (PANs) such as Bluetooth (IEEE 802.15 specification) and Wi-Fi (IEEE 802.11 specification). Thus, a wireless proximity network should be differentiated from long-range wireless networks, such as cellular networks for cellular or mobile phones and satellite communication networks.

7. Content Player and Wireless Adaptor

A portable content device such as the cellular phone 142 may send content to a content player such as the car audio system 143 via the wireless interface 150 of the cellular phone 142. As a wireless communication device, the cellular phone 142 may send and receive wireless communication signals, such as phone calls, to the car audio system 143 via its wireless interface 150 as well. In addition, a wireless adaptor 173 may be used to enable communication between the cellular phone 142 and the car audio system 143 for wirelessly: transferring communication signals to and from the cellular phone 142, receiving content from the cellular phone 142, and controlling playback of the received content. Thus, the wireless adaptor 173 presents a cost effective solution for integrating hands-free wireless communication functionality (e.g., phone calls) of a wireless communication device (e.g., the cellular phone 142), into a new or legacy vehicle audio system (e.g., the car audio system 143), wherein wireless communication sessions made through and received at the cellular phone 142 may be routed to the car audio system 143. Additionally, the wireless adaptor 173 may include a user interface thereon for controlling such wireless communication sessions (e.g., initiating, accepting, or rejecting calls, volume up/down).

The wireless adaptor 173 may add the convenience of displaying call metadata or information (e.g., caller ID, last dialed number, phone list, and other call history information), which is otherwise available on the cellular phone 142, on a display of the car audio system 143 through use of the available user interface on the wireless adaptor 173. Furthermore, the wireless adaptor 173 may provide seamless integration of the hands-free wireless communication functionality with the playback of an external content, such as audio stream, at the car audio system 143, such as resumption of content playback after a call is completed, interruption of content playback through automatic pausing or muting the content playback when receiving or during a call. The wireless adaptor 173 may be a part of or separate from the car audio system 143. In addition, or alternatively, a wired interface other than the wireless adaptor 173 may be used to enable the communications between the cellular phone 142 and the car audio system 143.

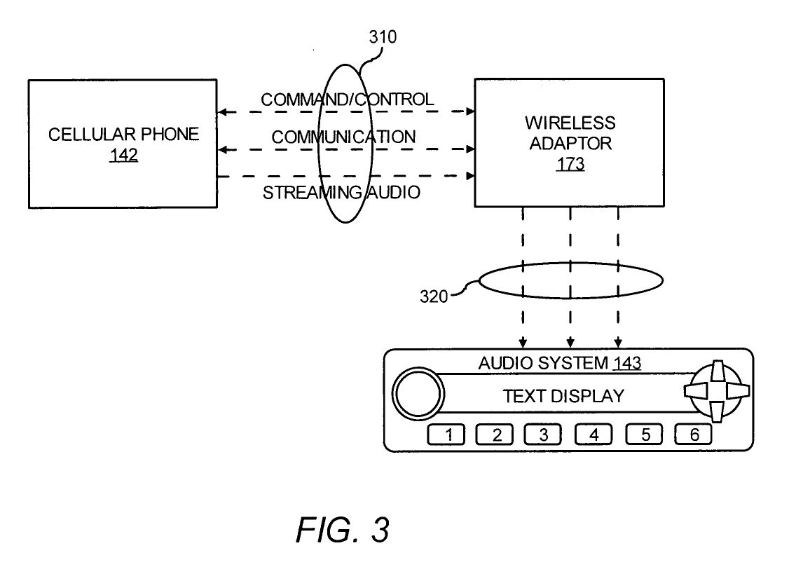

FIG. 3 illustrates an operating environment of the wireless adaptor 173, in accordance with one embodiment wherein the wireless adaptor 173 is separate and distinct from the car audio system 143. Thus, it is operable to be connected to an existing audio system, for example, in a legacy vehicle, without the need for a complete integration of the two devices or an initial factory installation of both devices. The wireless adaptor 173 allows a suitably-enabled portable content device and/or a wireless communication device to wirelessly integrate with an available radio component in a content player. Although FIG. 3 and the description hereinafter refer to the wireless communication device or the portable content device as a cellular phone 142, it should be understood that the cellular phone 142 is used merely as an example, and unless otherwise indicated, any other wireless communication device, or portable content device, may be used in its place. Examples of another portable content device include but are not limited to a digital music player and a PDA. Likewise, although FIG. 3 and the description hereinafter refer to an available radio component in a car audio system 143, it should be understood that such a car audio system is used merely as an example, and any other content player having an available radio component may be used in its place. Examples of another content player include but are not limited to a marine audio system on a boat, a home audio system, and any other audio device or system having a radio component.

In one embodiment, the wireless adaptor 173 uses a wireless proximity network to establish a wireless communication link 310 with the cellular phone 142. Additionally, the wireless adaptor 173 establishes a one-way wireless, radio communication link at 320 with an available radio component in the car audio system 143. Because the wireless adaptor 173 may be separate and distinct from the car audio system 143, as noted earlier, it may be used with any audio system, other than the car audio system 143, that has a radio component.

In one embodiment, the cellular phone 142 is suitably-enabled to wirelessly transmit communication signals, content, and command/control signals, encoded or unencoded, via the aforementioned wireless proximity network to the wireless adaptor 173. In turn, the wireless adaptor 173 maintains the wireless communication link 310 with the cellular phone 142 in accordance with the command/control signals it receives from the cellular phone 142. The wireless adaptor 173 also provides any needed signal conversion or decoding of the received content for forwarding to the car audio system 143. Thus, the wireless adaptor 173 provides an interface that allows the cellular phone 142 to: a) route wireless communication from the cellular phone 142 to the car audio system 143 to facilitate hands-free wireless communication functionality, b) transmit stored content to the car audio system 143 for content playback by the car audio system 143, or c) do both.

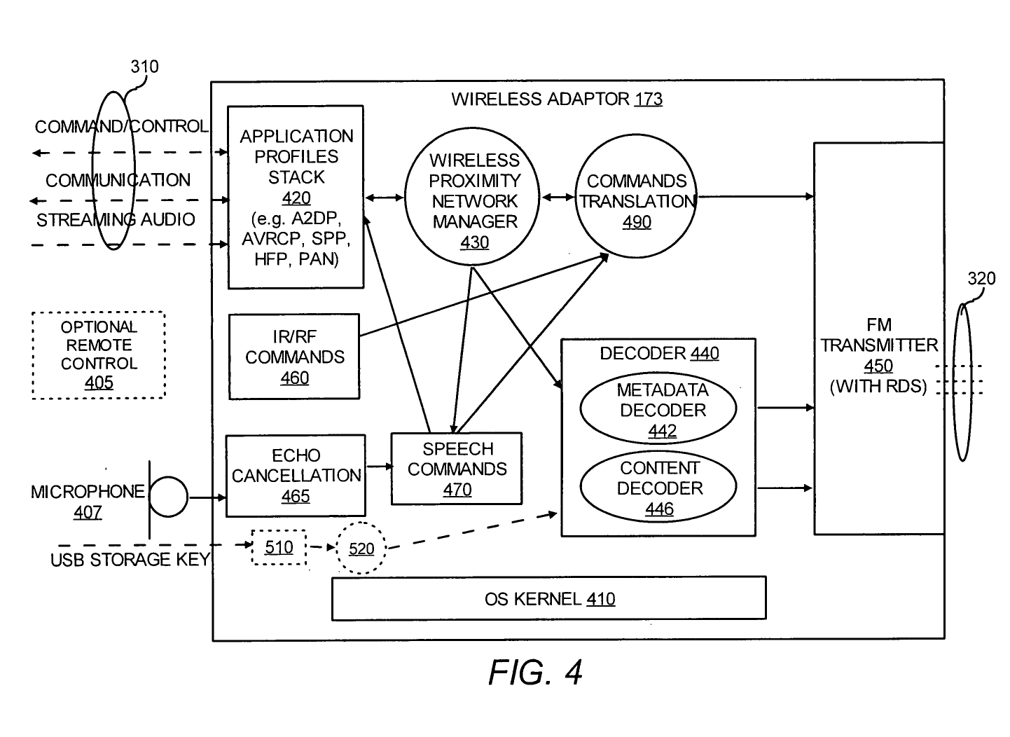

FIG. 4 illustrates the wireless adaptor 173 in further detail, in accordance with one embodiment. The wireless adaptor 173 includes an Operating System (OS) kernel 410 that manages the device's hardware and software operations, an application profiles stack 420 for the wireless proximity network that provides the wireless communication link between the car audio system 143 and the cellular phone 142 via the wireless adaptor 173, a decoder 440 having a content decoder 446 that decodes the content received from the cellular phone 142 and a metadata decoder 442 that decodes any metadata relating to the wireless communication functionality (e.g., caller ID, phone list, redial numbers, and other call history information) for the content (e.g., song titles, artist names, playlists) for displaying on the car audio system 143. In one embodiment, the content decoder 446 and metadata decoder 442 are implemented as program code, encoded on a CRM. Thus, it is possible to include in the program code for the metadata decoder 442 the particular display format to enable the displaying of the content metadata on the car audio system 143. The wireless adaptor 173 also includes hardware (not illustrated) for a baseband controller and radio that is used to receive radio-frequency (RF) signals from the cellular phone 142 and converting them into digital signals for processing by the applications profile stack 420. Thus, the RF hardware and the applications profile stack 420 provide the wireless adaptor 173 with a wireless interface for wireless communication with the cellular phone 142.

Once the content and any associated metadata are decoded, they are forwarded to the car audio system 143 via a Frequency-Modulation (FM) transmitter 450, which may be a part of the wireless adaptor 173 as shown in FIG. 4 or implemented as a separate transmitter wired out from the wireless adaptor 173. The FM transmitter 450 provides signal transmission to the car radio component in the car audio system 143 to enable a one-way wireless communication link 320 from the wireless adaptor 173 to the car audio system 143. In one embodiment, the FM transmitter 450 is operable to wirelessly or wire transmit communication signals and content to the car audio system 143 over any one of multiple predetermined frequencies, and the transmission frequency is selectable by a user via the commands translation module 490, which is described later. For wireless transmission, signals output by the wireless adaptor 173 are wirelessly transmitted as radio frequency (RF) signals to the car audio system 143 for reception by the car radio component therein. For wired transmission, signals output by the wireless adaptor 173 are transmitted as RF signals via a wired connection between the FM transmitter 450 and an RF receiving mechanism (e.g., radio antenna or RF receiver) at the car audio system 143 The FM transmitter 450 further includes a Radio Data System (RDS) capability that enables the FM transmitter 450 to receive metadata for the communication signals (e.g., caller ID, phone lists) and content as decoded by the metadata decoder 442, frequency modulates such content metadata onto a subcarrier frequency that is transmitted on the main transmission frequency used for carrying the content from the cellular phone 142. Thus, the FM transmitter 450 provides the car audio system 143 with information on the content being transmitted for display through its car radio component in a manner similar to the conventional display of radio station identifications, song names, and artist names from radio broadcastings by RDS-capable radio stations. The FM transmitter 450 also enables the wireless adaptor 173 to be used with various car audio systems from different manufacturers because content transmission to a car audio system is done through frequency modulation, which may be received by an available radio component in any car audio system. Thus, custom interface is not required for the communication link between the wireless adaptor 173 and the car audio system 143.

In one embodiment, the wireless adaptor 173 optionally includes an infra-red (IR), radio-frequency (RF), or IR and RF command module 460 to enable remote control of the wireless adaptor 173, the cellular phone 142, or both via a remote control 405. In one embodiment, the remote control 405 may include a display thereon for display of any data accessible by the wireless adaptor 173, such as metadata relating to the wireless communication functionality or content streaming or status of the wireless adaptor 173 and its connection to the cellular phone 142 and/or the car audio system 143. The wireless adaptor 173 also may include a speech command module 470 to enable control of the wireless adaptor 173, the cellular phone 142, or both via voice commands through a connected microphone 407, which may be integrated within the wireless adaptor 173 (not illustrated) or externally connected to the wireless adaptor 173 (as illustrated in FIG. 4). The microphone 407 also allows a user to communicate during a phone call as facilitated by the cellular phone 142, whereby the user's voice is picked up by the microphone 407, modulated and converted to electrical signals by the speech command module 470, as directed by the wireless proximity network manager 430 in a format understood by the application profiles stack 420, and wirelessly transmitted back to the cellular phone 142 by the application profiles stack 420 for wireless transmission out of the cellular phone 142.

The IR/RF command module 460 and the speech command module 470 are operable in place of or in conjunction with one another. Furthermore, each is operable in place of or in conjunction with the application profile stack 420 and the network manager 430. When the user employs the remote control 405 to access the wireless communication functionality or control playback of the content from the cellular phone 142 through the car audio system 143, the IR/RF control signals from the remote control 405 are received by the IR/RF command module 460 via an IR/RF receiver in the wireless adaptor 173 (not illustrated). The IR/RF command module 460 provides conversion of the IR/RF control signals into corresponding electrical signals for forwarding to the command translation module 490, which then provides translation of such electrical signals to control the wireless adaptor 173, the cellular phone 142, or both, or for sending out the signals as communication signals in a phone call.

In one embodiment, the wireless adaptor 173 further includes an echo cancellation module 465, which may be hardware and/or software implemented as understood in the art, to eliminate or attenuate sound echoes typically present in audio reception by the microphone 407 before they reach the speech commands module 470.

The speech command module 470 enables a user to give voice commands through the connected microphone 407 to control the wireless communication functionality of the cellular phone 142 or playback of content from the cellular phone 142 through the car audio system 143. For example, the user may use voice commands for voice dialing of phone numbers through predefined voice tags, such as “dial 1” for one pre-programmed phone number associated with the predefined voice tag “1” and “dial 2” for another pre-programmed phone number associated with the predefined voice tag “2”. Such voice commands are converted into electrical signals by the speech command module 470 for forwarding to the command translation module 490, which then provides translation of such electrical signals to control the wireless adaptor 173, the cellular phone 142, or both. As mentioned earlier, the speech command module 470 (in conjunction with the microphone 407) also allows a user to communicate during a phone call facilitated by the cellular phone 142. In an alternative embodiment, separate speech modules may be used to handle phone calls and voice commands. The use of the remote control 405 or voice commands through the microphone 407 in place of the cellular phone 142 to control content playback may provide additional safety to a user that is a driver of the vehicle, in which the cellular phone 142, the wireless adaptor 173, and the car audio system 173 are located or in proximity, because the use of the remote control 405 or voice commands may be less distracting to the user. The use of the wireless adaptor 173 with the microphone 407 for making hands-free phone calls is less distracting and enhances the driver's safety in operation the vehicle as well.

The commands translation module 490 includes program code, encoded on a CRM, suited for translating the aforementioned control signals from the IR/RF command module 460 and the speech command module 470. The commands translation module 490 also may include program code, encoded on a CRM, suited for translating command/control signals received at 310 from the cellular phone 310. For instance, a user may select from a user interface of the cellular phone 143 a desired transmission frequency for content playback through the car radio component of the car audio system 143. The cellular phone 143 then transmits the user's selection as command/control signals to the wireless adaptor 143, which receives the command/control signals, as facilitated by the applications profiles stack 420, and translates such command/control signals into a format that is understood by the FM transmitter 450.

To manage the communication links 310 and 320 for facilitating hands-free wireless communication with the car audio system 143 or wireless transfer of content from the cellular phone 142 to the car radio system 143, the wireless adaptor 173 further includes a proximity wireless network manager 430 that runs the application profiles stack 420 to set up and control the wireless communication link 310, interacts with the decoder 440 to decode content and any content metadata, interacts with the speech commands module 460 to receive audio input by the user at the microphone 407, and interacts with the commands translation module 490 to facilitate the transmission at 320 of the decoded content and content metadata to the car radio system 143 via the FM transmitter 450. In one embodiment, the network manager 430 includes program code, encoded on a CRM, for performing the aforementioned functions.

FIG. 4 illustrates one example of the applications profile stack 420 having a number of Bluetooth profiles to regulate the transmission of content and wireless communication signals, such as phone calls, between the cellular phone 142 and the car audio system 143 via the wireless adaptor 13, as well as the transmission of command/control signals between the cellular phone 142 and the wireless adaptor 173. In one embodiment, the applications profile stack 420 is implemented as program code encoded on a CRM. Examples of Bluetooth profiles that may be used in the applications profile stack 420 include but are not limited to the Advanced Audio Distribution Profile (A2DP), the Audio Video Remote Control Profile (AVRCP), the Serial Port Profile (SPP), the Hands-Free Profile (HFP), the Extended Service Discover Profile (ESDP), and the Personal Area Network (PAN) profile. In order for the wireless adaptor 173 and the cellular phone 142 to work together through the Bluetooth transport, the cellular phone 142 is to include the same Bluetooth profiles found in the wireless adaptor 173. Although FIG. 4 and the description herein refer to the use of Bluetooth profiles, it should be understood that the profiles used merely depend on the type of wireless proximity network used to provide the communication link between the cellular phone 142 and the car audio system 143.

When the wireless adaptor 173 is in operation, the A2DP therein enables the wireless adaptor 173 to: a) transfer communication signals from the cellular phone 142 to the car audio system 143 for wireless communication via the cellular phone 142 and facilitated hands-free by the car audio system 143; b) wirelessly transfer the content, such as audio content, stored in the cellular phone 142 to the car audio system 143 as streaming audio for audio playback through the later; or c) do both. As described earlier, the stored content is located in respective channels in the cellular phone 142. The network manager 430 further controls the content decoder 446 to decode the streaming audio into a format understood by the FM transmitter 450 for frequency modulation and radio transmission, which is then received for playback by the car audio system 143 via its car radio component. The SPP provides each of the cellular phone 142 and car audio system 143 with a virtual serial port for wireless connection, through emulation of RS-232 control signal communication, between the devices (rather than with an actual serial cable) to form the wireless proximity network. Thus, the SPP may be used in place of the A2DP to: a) transfer content from the cellular phone 142 to the car audio system 143; b) provide remote control use of the cellular phone 142 or the wireless adaptor 173 by the remote control 405 or by voice commands through the microphone 407; and c) provide remote control use of the wireless adaptor 173 by the cellular phone 142. It should be understood that the SPP defines the serial port emulation for wireless connection via RF communication (RFCOMM). Thus, alternative embodiments are contemplated wherein SPP can be bypassed, and the underlying RFCOMM protocol can be used directly to provide emulation of a serial port for wireless connection. The AVRCP also may be used in place of the SPP for wireless connection to ensure interoperability of functional controls between the cellular phone 142 and the wireless adaptor 173 (via an available user interface thereon) for content access and playback via FM transmission to the car audio system 143.

As referred herein, a functional control of a device is a control that is capable of controlling a function of such a device. Thus, both the SPP and AVRCP enable the cellular phone 142 to be remotely controlled by the remote control 405, voice commands through the microphone 407 (through the wireless adaptor 173), or a user interface located on the wireless adaptor 173, via the wireless proximity network. For instance, the SPP or AVRCP enables the remote control 405 to act as a controller that sends audio command/control signals to the cellular phone 142 for playback of an audio stream or phone command/control signals for wireless communication. In another instance, the SPP or AVRCP enables the user to send audio command/control signals, via the remote control 405 or voice commands through the microphone 407 or a user interface available on the wireless adaptor 173, to the cellular phone 142 for content playback or phone command/control signals for the wireless communication functionality. Examples of command/control signals for content playback include playback, stop, channel selection, and display mode, depending on the nature of the devices involved (the cellular phone 142 and the wireless adaptor 173 in this instance) and the desired scenario for accessing the audio stream through the car audio system 143. Examples of command/control signals for wireless communication functionality includes accepting incoming call, rejecting incoming call, hanging up a call, initiate an outgoing call, and any other phone functions that is available through the user interface of the cellular phone 142.

In one embodiment, the wireless adaptor 173 includes a switch to provide the user with an option to either maintain or disable the user interface on the cellular phone 142 for control upon an establishment of the wireless proximity network for the wireless communication link between the cellular phone 142 and the wireless adaptor 173. As a result, the cellular phone 142 is controllable by the functional controls on its own user interface, the functional controls on the remote control 405, the functional controls on the user interface of the wireless adaptor 173, or the function controls on any combination of these three devices at any time.

The HFP is included to allow the car audio system 143 to handle incoming phone calls to the cellular phone 142. Thus, the HFP may be used to enable two-way audio and call status between the wireless adaptor 173 and the cellular phone 142 to facilitate hands-free wireless communication through the car audio system 173, with associated controls accessible through an available user interface on the wireless adaptor 143. In one embodiment, when a wireless communication session is externally initiated, e.g., a phone call coming in through the cellular phone 142, the user is notified by an alert tone transmitted from the wireless adaptor 173 to the car audio system 143 via FM modulation through the FM transmitter 450, as directed by the wireless proximity network manager 430 and translated by the commands translation module 490. Thus, the alert tone may originate from the cellular phone 142, which is then fed through the wireless adaptor 173 to the car audio system 173. Alternatively, the alert tone may be generated within the wireless adaptor 173 in response to the incoming call. In another embodiment, alternative or in addition to the alert tone, the wireless transmitter 173 transmits an alert radio text via its aforementioned RDS capability for display at the car audio system 143. The alert radio text may include metadata of the incoming phone call, such as a caller ID identifying the caller's number or name, as pre-programmed in the cellular phone 142 or provided by the wireless communication provider. As with the alert tone, the alert text may originate from the cellular phone 142 and fed through the wireless adaptor 173 or be generated by the wireless adaptor 173 in response to the incoming call.

The PAN profile allows the Bluetooth devices involved to participate in a personal area network that is used for communication among devices in proximity to each other. In this case, the involved Bluetooth devices are the car audio system 143 that is Bluetooth-enabled via the wireless adaptor 173 and the cellular phone 142 that is Bluetooth-enabled and in proximity to the wireless adaptor 173 (for example, in the same car where the car audio system 143 is installed). Thus, the PAN profile allows the wireless adaptor 173 to send its status and identification information to the cellular phone 142 so as to establish a communication link with the cellular phone 142. The PAN profile also may be used to transfer content from the cellular phone 142 to the car audio system 143 via the wireless adaptor 173.

The ESDP employs a detection protocol that allows a Bluetooth device to discover any other Bluetooth device that is in proximity to the wireless adaptor 173, and hence the car audio system 143, and to establish a communication link with the nearby Bluetooth device over a network (such as a personal area network) with a network profile (such as the PAN profile). Thus, the wireless adaptor 173 supports a detection protocol that enables a target device, such as the car audio system 143, to dynamically detect a portable content device, such as the cellular phone 142, and to automatically interface with the cellular phone 142 for facilitating hands-free wireless communication functionality and content streaming therefrom without requiring any user's interaction. For example, a user having a powered-up cellular phone 142 in a pocket, a brief case, a purse, or a glove compartment in a car equipped with the car audio system 143 and a FM wireless adaptor 173 does not need to retrieve the cellular phone 142 and activate a communication link with the wireless adaptor 173. Instead, the car wireless adaptor 173 automatically detects the presence of the cellular phone 142, establishes a communication link with the cellular phone 142 via the wireless proximity network, facilitates hands-free phone functionality through the car audio system 143, and initiates the audio streaming from the cellular phone 142 to the car audio system 143, whereby a user is able to listen to the content streaming, such as audio streaming, through the car audio system 143 if the car audio system 143 is on, or upon powered up, and set to function in the radio mode at the selected transmission frequency. Thus, from the perspectives of the cellular phone 142 and the user, it matters not which target device is the subject of the FM transmission from the wireless adaptor 173 because of the seamless integration and standardization of functions provided by the wireless adaptor 173.

Accordingly, the wireless adaptor 173 enables the content from or communication signals, such as phone calls, received or made by the cellular phone 142 to be played or heard with minimal user interaction over any target device that is capable of receiving FM transmission at a selected frequency from the wireless adaptor 173. For example, incoming phone calls may be accepted or ignored, and outgoing calls may be made, via controls on the user interface of the cellular phone 142 or the wireless adaptor 173, with call audio heard over the car audio system 173. The wireless adaptor 173 also enables the content from the cellular phone 142 to be played and controlled by the remote control 405 or an available user interface on the wireless adaptor 173. For example, the remote control 405 or an available user interface on the wireless adaptor 173 may include buttons or controls for accessing the various different content channels available in the cellular phone 142 and for skipping forward or backward the content in a particular content channel, if the content includes the user's content or individual pieces of content that is controllable in such a manner. In another example, the user's voice commands as received through the microphone 407 are operable to control the play, forward, and backward functions for accessing content in the cellular phone 142, if the content includes the user's content or individual pieces of content that is controllable in such a manner.

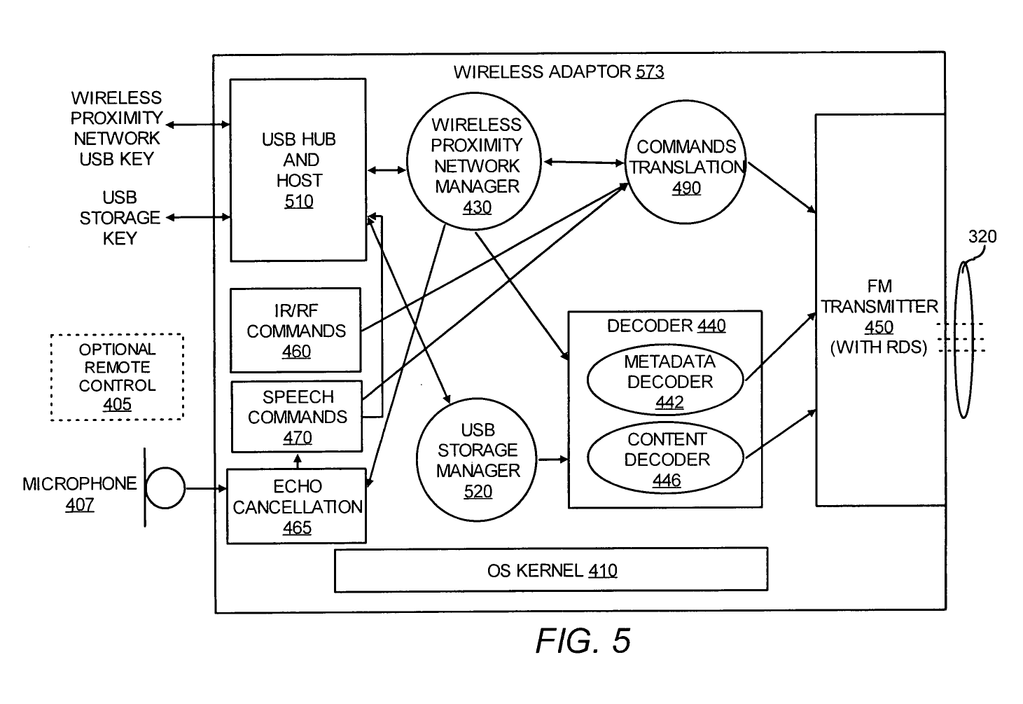

FIG. 5 illustrates a wireless adaptor 573, in accordance with an alternate embodiment. As with the wireless adaptor 173, the wireless adaptor 573 includes the OS kernel 410, the network manager 430, the decoder 440 with the metadata decoder 442 and the content decoder 446, a commands translation module 490, and the FM transmitter 450. However, the wireless adaptor 573 includes a Universal Serial Bus (USB) hub and host 510 in place of the application profiles stack 420.

The USB hub and host 510 enables a connection of a transceiver for a proximity wireless network. The transceiver includes the functionality of the application profiles stack 420 described earlier for the wireless adaptor 173 in FIG. 4. For instance, a Bluetooth or Wi-Fi USB key is operable for connection to the USB hub and host 510 to establish the wireless communication between the cellular phone 142 and the car audio system 143 via the wireless adaptor 573 as described earlier. Although FIG. 5 illustrates a USB connection, it should be noted that other types of connection are also applicable. For instance, one alternate connection is a Firewire (IEEE 1394).

The USB storage manager 520 manages the retrieval and transfer of any content and content metadata stored on any USB storage key that is connected to the wireless adaptor 573 via the USB hub and host 510, to the car audio system 143 as streaming content for audio playback and metadata display through the later. Thus, the USB hub and host 510 acts a wired interface that allows a content storage device to be connected to the wireless adaptor 573 for content transfer. As with the transfer of content from the cellular phone 142, the content and content metadata from the USB storage key are decoded by the decoder 440 for playback and displayed, respectively, by the car audio system 143. In this embodiment, the wireless adaptor 573 may include a user interface located thereon, as noted earlier, that allows a user to control the playback (e.g., play, pause, skip, rewind, forward) of the content received by the USB hub and host 510.

Referring back to FIG. 4, in another embodiment, the USB hub and host 510, and the associated USB storage manager 520, may be added to the wireless adaptor 173 illustrated in FIG. 4 to allow any additional content storage device, other than the cellular phone 142, to be connected to the wireless adaptor 173 for content transfer.

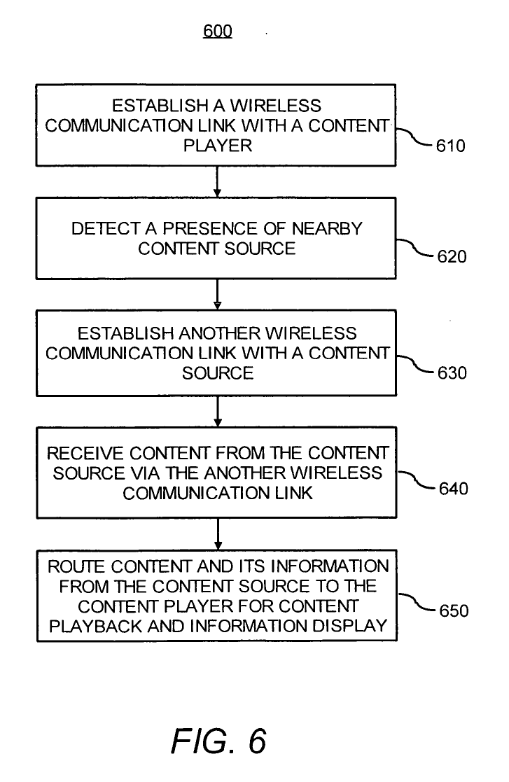

FIG. 6 illustrates a method 600 for wirelessly providing a content stored in a content source, such as the cellular phone 142, to a content player, such as the car audio system 143. The method 600 is described with respect to FIGS. 1-5 by way of example and not of limitation. It will thus be apparent to one of ordinary skill in the art that the method 600 may be performed with systems and devices other than those depicted in FIGS. 1-5.

Referring now to FIG. 6, at 610 the wireless adaptor 173 (or 573) establishes a wireless communication link with a content player, such as the car audio system 143, through a FM transmission at a selected frequency to an available radio component in the content player. At 620 the wireless adaptor 173 (or 573 with a connected transceiver) detects a presence of a content source nearby or in proximity to the wireless adaptor 173 (or 573). At 630 the wireless adaptor 173 (or 573) also establishes a wireless communication link with a nearby content source, such as the cellular phone 142, through a wireless proximity network, such as a Bluetooth or Wi-Fi network, to access the content stored in the cellular phone 142. As described earlier, the content stored in cellular phone 142 may have been previously downloaded from the content service 120 via the Internet 131, cellular network 132, and optionally through the personal computer 141. The wireless proximity network is facilitated by the application profiles stack 420, in the case of the wireless adaptor 173, or a transceiver such as a Bluetooth or Wi-Fi USB key that is connectible to the wireless adaptor in the case of the wireless adaptor 573.

At 640, the wireless adaptor 173 (or 573) receives content, such as audio content, from the content source via the wireless communication link as established by the wireless proximity network. At 650, the wireless adaptor 173 (or 573) routes the content from the content source to the content player for content playback. The wireless adaptor 173 also may employ RDS broadcasting, as implemented by the FM transmitter 450, to route information about the content to the content player for display at the content player as well.

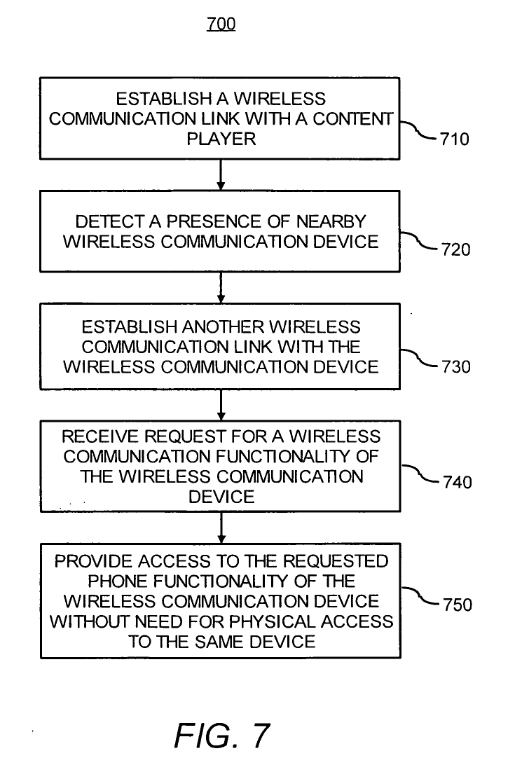

FIG. 7 illustrates a method 700 for enabling a user to access the wireless communication functionality of the cellular phone 142 via the wireless adaptor 173 for wireless communication. The method 700 is described with respect to FIGS. 1-5 by way of example and not of limitation. It will thus be apparent to one of ordinary skill in the art that the method 700 may be performed with systems and devices other than those depicted in FIGS. 1-5.

Referring now to FIG. 7, at 710 the wireless adaptor 173 (or 573) establishes a wireless communication link with a content player, such as the car audio system 143, through a FM transmission at a selected frequency to an available radio component in the content player. At 720 the wireless adaptor 173 (or 573 with a connected transceiver) detects a presence of a wireless communication device, such as the cellular phone 142, nearby or in proximity to the wireless adaptor 173 (or 573). At 730 the wireless adaptor 173 (or 573) also establishes a wireless communication link with the nearby cellular phone 142 through a wireless proximity network, such as a Bluetooth or Wi-Fi network, to gain access to the wireless communication functionality of the cellular phone 142. The wireless proximity network is facilitated by the application profiles stack 420, in the case of the wireless adaptor 173, or a transceiver such as a Bluetooth or Wi-Fi USB key that is connectible to the wireless adaptor in the case of the wireless adaptor 573.

At 740, the wireless adaptor 173 (or 573) receives a command/control signal requesting a wireless communication functionality of the cellular phone 142. The requested wireless communication functionality may be initiated by the cellular phone 142, a user's input from the remote control 405, the microphone 407, or a user interface available on the wireless adaptor 173. For example, as mentioned earlier, the requested wireless communication functionality may be initiated by the cellular phone 142 because of an incoming call, whereby the user is requested to accept or reject the call, or an outgoing call, whereby the user initiates the outgoing call via the user interface on the cellular phone 142 (keypad, redial key, etc. thereon). In another example, the requested wireless communication functionality may be initiated by a user's input via the remote control 405, voice commands received at the microphone 407, or the user interface on the wireless adaptor 173, for handling an incoming or outgoing phone call at the cellular phone 142.

At 750, the wireless adaptor 173 (or 573) provides access to the requested wireless communication functionality of the cellular phone 142, via the wireless communication link as established by the wireless proximity network, without the need to physically access the cellular phone 142. For example, if the requested wireless communication functionality is initiated by the cellular phone 142 because of an incoming call, the wireless adaptor 173 may send out an alert tone and/or radio text to the car audio system 143, as described earlier, to alert the user of the incoming call, whereby the user is prompted to accept or reject the call with input via the remote control 405, voice commands through the microphone 407, or an available user interface on the wireless adaptor 173 (in addition to or in lieu of the user interface on the cellular phone 142). Once the user responds to the prompt, the wireless adaptor 173 communicates with the cellular phone 142 via the wireless communication link established by the wireless proximity network to relay commands to the cellular phone 142 to carry out the corresponding wireless communication functionality.

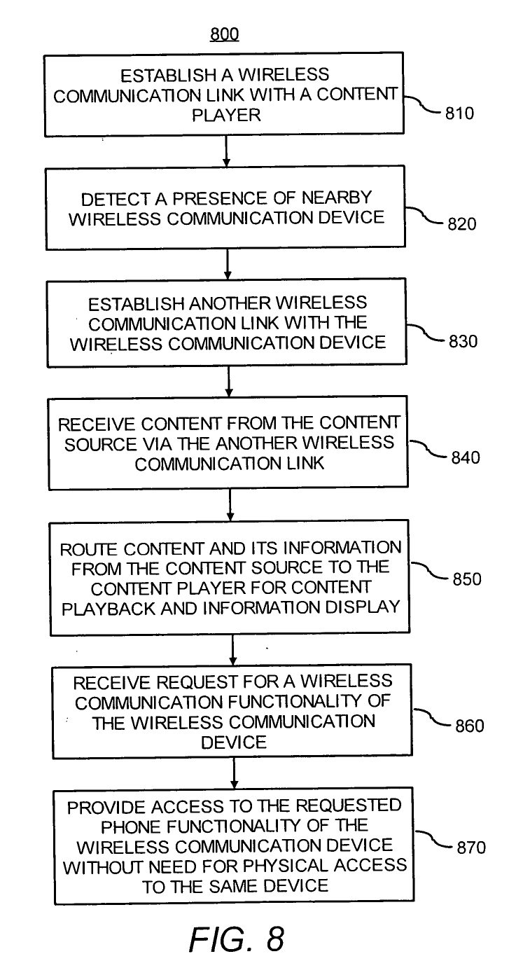

FIG. 8 illustrates a method 800 for enabling a user to access the wireless communication functionality of the cellular phone 142 via the wireless adaptor 173 for wireless communication and for wirelessly providing a content stored in a content source, such as the cellular phone 142, to a content player, such as the car audio system 143. The method 800 is described with respect to FIGS. 1-5 by way of example and not of limitation. It will thus be apparent to one of ordinary skill in the art that the method 800 may be performed with systems and devices other than those depicted in FIGS. 1-5.

Referring now to FIG. 8, at 810 the wireless adaptor 173 (or 573) establishes a wireless communication link with a content player, such as the car audio system 143, through a FM transmission at a selected frequency to an available radio component in the content player. At 820, the wireless adaptor 173 (or 573 with a connected transceiver) detects the presence of a wireless communication device, such as the cellular phone 142, which is also a content source, nearby or in proximity to the wireless adaptor 173 (or 573). At 830, the wireless adaptor 173 (or 573) also establishes a wireless communication link with the nearby cellular phone 142 through a wireless proximity network, such as a Bluetooth or Wi-Fi network, to gain access to the wireless communication functionality of the cellular phone 142 and content stored therein. As described earlier, the content stored in cellular phone 142 may have been previously downloaded from the content service 120 via the Internet 131, cellular network 132, and optionally through the personal computer 141. The wireless proximity network is facilitated by the application profiles stack 420, in the case of the wireless adaptor 173, or a transceiver such as a Bluetooth or Wi-Fi USB key that is connectible to the wireless adaptor in the case of the wireless adaptor 573.

At 840, the wireless adaptor 173 (or 573) receives content, such as audio content, from the content source via the wireless communication link as established by the wireless proximity network. At 850, the wireless adaptor 173 (or 573) routes the content from the content source to the content player for content playback. The wireless adaptor 173 also may employ RDS broadcasting, as implemented by the FM transmitter 450, to route information about the content to the content player for display at the content player as well.

At 860, the wireless adaptor 173 (or 573) receives a command/control signal requesting a wireless communication functionality of the cellular phone 142. The requested wireless communication functionality may be initiated by the cellular phone 142, a user's input from the remote control 405, the microphone 407, or a user interface available on the wireless adaptor 173. For example, as mentioned earlier, the requested wireless communication functionality may be initiated by the cellular phone 142 because of an incoming call, whereby the user is requested to accept or reject the call, or an outgoing call, whereby the user initiates the outgoing call via the user interface on the cellular phone 142 (keypad, redial key, etc. thereon). In another example, the requested wireless communication functionality may be initiated by a user's input from the remote control 405, via voice commands received at the microphone 407, or from the user interface on the wireless adaptor 173, for accepting or rejecting an incoming call or initiating an outgoing call.

At 870, the wireless adaptor 173 (or 573) provides access to the requested wireless communication functionality of the cellular phone 142, via the wireless communication link as established by the wireless proximity network, without the need to physically access the cellular phone 142. For example, if the requested wireless communication functionality is initiated by the cellular phone 142 because of an incoming call, the wireless adaptor 173 may send out an alert tone and/or radio text to the car audio system 143, as described earlier, to alert about the incoming call, whereby the user is prompted to accept or reject the call with input via the remote control 405, voice commands through the microphone 407, or an available user interface on the wireless adaptor 173 (in addition to or in lieu of the user interface on the cellular phone 142). In one embodiment, if an incoming call to the cellular phone 142 is received during content playback from the cellular phone 142 to the car audio system 143, the alert tone is transmitted to the car audio system 143 for output at a sufficiently high volume to interrupt the content playback (e.g., through attenuation or muting of the content playback volume relative to the alert tone) and ensure that it is heard over the car audio system 143 to warn the user of an incoming call. Likewise, sound received by the cellular phone 142 during a phone call is transmitted by the wireless adaptor 173 for output at a sufficiently high volume to interrupt the content playback and ensure that the phone call is heard over the car audio system 143.

According to one embodiment, the wireless adaptors 173 and 573 in FIGS. 4 and 5 include both hardware and software. In one embodiment, each of the wireless adaptors 173 and 573 is implemented as a System-on-a-Chip (SoC) solution, with one or more computer chips, each includes one or more processors, such as microprocessors or digital signal processors, and one or more CRMs that include program codes for the implementation of the application profiles stack 420, the network manager 430, the commands translations module 490, the I/O manager 495, the decoder 440, the IR/RF commands module 470, and the speech commands module 470.

According to the aforementioned embodiments and variations thereof that are within the scope of the present disclosure, the wireless adaptor 173 facilitates hands-free wireless communication functionality to users for convenience and safety. With the wireless adaptor 173, a user no longer needs to physically access a wireless communication device, such as a cellular phone, in order to access the phone functionality for communication purposes or content playback. The elimination of a requirement for physical access of the wireless communication device simplifies the tasks that the user must perform to use the device, enhances the user's experience with the device, and provides safety to the user during operation of a vehicle.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for facilitating hands-free wireless communication functionality of a wireless communication device comprising the steps of:
first wirelessly routing a wireless communication signal received at a wireless communication device from the wireless communication device to a wireless adaptor, via a first wireless connection facilitated by a wireless proximity network;
second routing, through a second wireless connection or a wired radio-frequency (RF) connection that is different from the first wireless connection, the first-routed wireless communication signal from the wireless adaptor to a content player for signal playback.

2. The method of claim 1, wherein the wireless proximity network is one of a Bluetooth network and a Wi-Fi network, the wireless communication device is a cellular phone, and the content player is a vehicle audio system.

3. The method of claim 2, wherein the step of second routing comprises the steps of:
providing a frequency modulation (FM) of the first-routed wireless communication signal; and
wirelessly transmitting, through the second wireless connection, the first-routed wireless communication signal as a radio frequency (RF) signal based on the frequency modulation to the content player.

4. The method of claim 1, further comprising:
automatically detecting a presence of the wireless communication device in proximity to the content player; and
automatically establishing the wireless proximity network based on the automatic detection of the presence of the wireless communication device.

5. The method of claim 1, further comprising the steps of:
wirelessly receiving at the wireless adaptor, through the first wireless connection facilitated by the wireless proximity network, content from the wireless communication device other than the wireless communication signal; and
third wirelessly routing, through the second wireless connection, the content as wirelessly received at the wireless adaptor to the content player for playback at the received content.

6. The method of claim 5, further comprising the step of:
wirelessly transmitting from the wireless adaptor to the content player, through the second wireless connection, an audio alert of the wireless communication signal received at the wireless communication device prior to the step of first wirelessly routing.

7. The method of claim 6, wherein the step of wirelessly transmitting the audio alert comprises:
during the playback of the content at the content player, wirelessly transmitting the audio alert to interrupt the playback of the content.

8. The method of claim 5, further comprising the step of:
wirelessly transmitting from the wireless adaptor to the content player, through the second wireless connection via a radio data system (RDS) broadcast, a text alert of the phone call received by the wireless communication device prior to the step of first wirelessly routing.

9. The method of claim 1, further comprising:
receiving a voice command at the wireless adaptor for a functional control of the wireless communication device; and
automatically operating the wireless communication device in accordance with the functional control from the voice command.

10. The method of claim 1, further comprising:
receiving a remote command, from a remote source different from the wireless communication device, for a functional control of the wireless communication device; and
automatically operating the wireless communication device in accordance with the functional control from the remote command.

11. The method of claim 1, further comprising:
receiving a command from a user interface of the wireless adaptor for a functional control of the wireless communication device; and
automatically operating the wireless communication device in accordance with the functional control from the remote command.

12. A computer readable medium on which is encoded program code for facilitating hands-free wireless communication functionality and wirelessly providing content, the program code comprising:
program code for establishing a first wireless connection via a wireless proximity network with a cellular telephone;
program code for receiving stored content from the wireless communication device through the first wireless connection, wherein the stored content includes audio content;
program code for decoding the stored content as received for transmission to a content player through a second wireless connection for playback at the content player;
program code for receiving metadata for the stored content from the wireless communication device through the first wireless connection;
program code for decoding the metadata as received for transmission to the content player through the second wireless connection for display at the content player;
program code for receiving a transmission from the cellular phone of an incoming phone call received at the cellular phone via the first wireless connection; and
program code for transmitting the incoming phone call as received from the cellular phone to the content player for audio playback of the incoming phone call.

13. The computer readable medium of claim 12, further comprising:
program code for receiving an audio response to the incoming phone call; and
program code for transmitting, via the first wireless connection, the audio response to the cellular phone for subsequent wireless transmission of the audio response by the cellular phone to a source from which the incoming phone call originates.

14. The computer readable medium of claim 13, further comprising:
program code for receiving a command for a selected radio frequency for the transmission of the stored content, the metadata of the stored content, and the incoming phone call to the content player via the second wireless connection.

15. The computer readable medium of claim 14, further comprising:
program code for receiving at least one of a voice command, a wireless remote command from a remote source different from the cellular phone, and a wired command for a functional control of the cellular phone;
program code for translating the at least one of the voice command, the wireless remote command, and the wired command; and
program code for wirelessly transmitting the translated command to the cellular phone via the first wireless network to effect performance of the functional control at the cellular phone.

16. The computer readable medium of claim 12, wherein the program code for receiving a transmission from the cellular phone of an incoming phone call received at the cellular phone comprises:
program code for receiving information about the incoming phone call;
program code for preventing the display of the metadata for the stored content at the content player;
program code for preventing or pausing the playback of the stored content at the content player; and
program code for transmitting the received information about the incoming phone call to the content player for display at the content player.

17. A wireless adaptor for facilitating hands-free wireless communication functionality of a wireless communication device comprising:
a first wireless interface operable to form a wireless proximity network with a wireless communication device to wirelessly access a wireless communication functionality of the wireless communication device; and
a second wireless interface that provides a wireless connection with a content player for playback of wireless communication signals received at the wireless communication device.

18. The wireless adaptor of claim 17, wherein:
the first wireless interface is further operable to wirelessly receive a content from the wireless communication device; and
the second wireless interface provides routing of the content through the wireless connection for playback by the content player.

19. The wireless adaptor of claim 18, wherein the first wireless interface is further operable to receive first metadata of the content and second metadata of the wireless communication signals, and the second wireless interface is further operable to provide a routing of the first and second metadata through the wireless connection to the content player for alternate displaying of the first and second metadata at the content player.

20. The wireless adaptor of claim 17, further comprising:
a voice command module operable to receive a voice command from a source different from the content source and to convert the voice command to a command for the wireless communication functionality of the wireless communication device.

21. The wireless adaptor of claim 20, wherein the voice command module is further operable to receive and modulate an audio response into a communication signal for wireless transmission by the wireless communication device.

22. The wireless adaptor of claim 17, further comprising:
a content interface operable to provide a connection of a content source to the wireless adaptor to receive content stored in the content source for playback by the content player.

23. The method of claim 2, wherein the step of second routing comprises the steps of:
providing a frequency modulation (FM) of the first-routed wireless communication signal; and
transmitting, through the wired RF connection, the first-routed wireless communication signal as a radio frequency (RF) signal based on the frequency modulation to the content player.
